(19) United States
(12) Patent Application Publication
(10) Pub. No.: US 2013/0113636 A1
(43) Pub. Date: May 9, 2013

(54) APPARATUS AND METHOD FOR AUTOMATICALLY APPLYING METEOROLOGICAL INFORMATION FOR AIRCRAFT TRAFFIC CONTROL

(71) Applicants: Seung-Hee Oh, Daejeon (KR); Deok Gyu Lee, Daejeon (KR); Seoung hyeon Lee, Daejeon (KR); Yong Kyun Kim, Daejeon (KR); Jong-Wook Han, Daejeon (KR); Hyo-Dal Park, Incheon (KR)

(72) Inventors: Seung-Hee Oh, Daejeon (KR); Deok Gyu Lee, Daejeon (KR); Seoung hyeon Lee, Daejeon (KR); Yong Kyun Kim, Daejeon (KR); Jong-Wook Han, Daejeon (KR); Hyo-Dal Park, Incheon (KR)

(73) Assignees: INHA Industry Partnership Institute, Incheon (KR); Electronics and Telecommunications Research Institue, Daejeon (KR)

(21) Appl. No.: 13/620,584

(22) Filed: Sep. 14, 2012

(30) Foreign Application Priority Data
Nov. 8, 2011 (KR) 10-2011-0115621

(51) Int. Cl. G01C 21/00

(52) U.S. Cl. 340/971

(57) ABSTRACT

An apparatus for automatically applying meteorological information includes a meteorological information classifying unit configured to automatically classify various types of meteorological information discriminately depending on their formats; and a meteorological information parsing unit configured to perform parsing to cut meteorological information classified by the meteorological information classifying unit. Further, the apparatus includes a meteorological information verifying unit configured to verify a syntax error and semantic content with respect to the meteorological information; and a meteorological message generating unit configured to generate a meteorological message by extracting only items required for air control from the meteorological information. Furthermore, the apparatus includes a meteorological message transmission unit configured to transmit the meteorological message generated by the meteorological message generating unit to a controller working position (CWP) system that performs air control.

### CROSS-REFERENCE TO RELATED APPLICATION(S)

The present invention claims priority of Korean Patent Application No. 10-2011-0115621, filed on Nov. 8, 2011, which is incorporated herein by reference.

### FIELD OF THE INVENTION

The present invention relates to an apparatus and method for automatically applying meteorological information for aircraft traffic control; and more particularly, to an apparatus and method for automatically applying meteorological information for aircraft traffic control capable of automatically receiving and processing in real time various types of meteorological information used in the aircraft traffic control.

### BACKGROUND OF THE INVENTION

As well-known in the art, meteorological information such as the direction and intensity of wind, a distance of vision and the like in aerodrome control of controlling departure and arrival of aircraft is important information utilized for setting runway (or landing), maintaining space between airplanes, and the like.

According to the prior art, a scheme for automatically receiving and processing in real time various types of meteorological information used in aircraft traffic control has not been proposed yet.

Thus, various types of meteorological information cannot be accurately provided to an air controller in real time.

### SUMMARY OF THE INVENTION

In view of the above, the present invention provides to an apparatus for automatically applying meteorological information for aircraft traffic control capable of automatically receiving and processing in real time various types of meteorological information used in the aircraft traffic control.

Further, the present invention provides a method for automatically applying meteorological information for aircraft traffic control, which can be applied to a next-generation aircraft control system in the future, as well as to an existing aircraft control system, by accurately and effectively processing meteorological information affecting departure and arrival of aircraft.

In accordance with a first aspect of the present invention, there is provided an apparatus for automatically applying meteorological information. The apparatus includes a meteorological information classifying unit configured to automatically classify various types of meteorological information discriminately depending on their formats; a meteorological information parsing unit configured to perform parsing to cut meteorological information classified by the meteorological information classifying unit by configuration fields differently depending on their types based on classified content; a meteorological information verifying unit configured to verify a syntax error and semantic content with respect to the meteorological information parsed by the meteorological information parsing unit; a meteorological message generating unit configured to generate a meteorological message by extracting only items required for air control from the meteorological information verified by the meteorological information verifying unit; and a meteorological message transmission unit configured to transmit the meteorological message generated by the meteorological message generating unit to a controller working position (CWP) system that performs air control.

Further, when an adaptation file regarding a new meteorological information format is received, the meteorological information classifying unit may add a new meteorological information format through a confirmation procedure.

In accordance with a second aspect of the present invention, there is provided a method for automatically applying meteorological information by an apparatus for automatically applying meteorological information, the method including: automatically classifying various types of input meteorological information discriminately depending on their formats; performing parsing to cut the classified meteorological information by configuration fields differently depending on types based on classified content; verifying a syntax error and semantic content with respect to the parsed meteorological information; generating a meteorological message by extracting only items required for air control from successfully verified meteorological information; and transmitting the generated meteorological message to a controller working position (CWP) system that performs air control.

The method may further comprise, when an adaptation file regarding a new meteorological information format is received, adding a new meteorological information format for aircraft traffic control through a confirmation procedure.

Further, said adding a new meteorological information format may further include checking a meteorological information component with respect to the new meteorological information format; generating a storage database table for storing the corresponding meteorological information based on the checked meteorological information component; and generating a component verification rule applied based on information of the checked meteorological information component.

In accordance with the embodiments of the present invention, various types of meteorological information applied in aircraft traffic control are automatically received and processed in real time, and meteorological information affecting departure and arrival of aircraft can be accurately and effectively processed.

Thus, the efficiency and accuracy of the aircraft control system can be improved.

In addition, since parsing and verification method is supported for flexible and extendable meteorological information, even newly added meteorological information, as well as existing meteorological information, can be processed.

### BRIEF DESCRIPTION OF THE DRAWINGS

The above and other objects and features of the present invention will become apparent from the following description of embodiments, given in conjunction with the accompanying drawings, in which:

FIG. 1 is a view illustrating a flight data processing system including an apparatus for automatically applying meteorological information in accordance with an embodiment of the present invention, and a network environment thereof;

FIG. 2 is a view illustrating a detailed configuration of the apparatus for automatically applying meteorological information in accordance with an embodiment of the present invention;

FIG. 3 is a flow chart illustrating a method for automatically applying meteorological information performed by the apparatus for automatically applying meteorological information in accordance with an embodiment of the present invention; and

FIG. 4 is a flow chart illustrating a method for adding a meteorological information format performed by the apparatus for automatically applying meteorological information in accordance with an embodiment of the present invention.

### DETAILED DESCRIPTION OF THE EMBODIMENTS

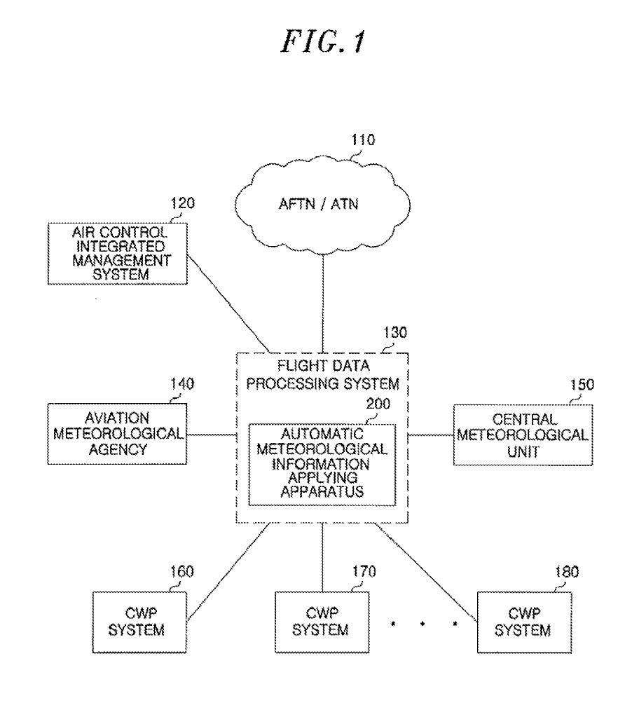

FIG. 1 is a view illustrating a flight data processing system including an apparatus for automatically applying meteorological information in accordance with an embodiment of the present invention, and a network environment thereof.

As illustrated in FIG. 1, a flight data processing system 130 including an apparatus 200 for automatically applying meteorological information constitute an AFTN (Aeronautical Fixed Telecommunication Network)/ATN (Aeronautical Telecommunication Network), an air control integrated management system 120, an aviation meteorological agency 140, a central meteorological unit 150, controller working position (CWP) systems 160, 170, and 180, and the like.

Various types of meteorological information are provided from the AFTN/ATN 110, the air control integrated management system 120, the aviation meteorological agency 140, or the central meteorological unit 150 to the flight data processing system 130, and the apparatus 200 for automatically applying meteorological information of the flight data processing system 130 automatically receives and processes the various types of meteorological information in real time and delivers the information to the CWP systems, i.e., a CWP system 1 160, a CWP system 2 170, . . . , a CWP system n 180 that ultimately perform air control.

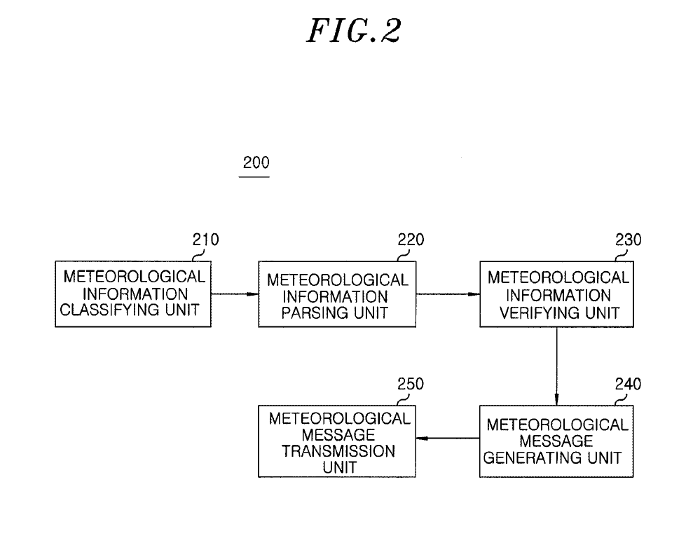

FIG. 2 is a view illustrating a detailed configuration of the apparatus for automatically applying meteorological information in accordance with an embodiment of the present invention.

As illustrated in FIG. 2, the apparatus 200 for automatically applying meteorological information includes a meteorological information classifying unit 210, a meteorological information parsing unit 220, a meteorological information verifying unit 230, a meteorological message generating unit 240, a meteorological message transmission unit 250, and the like.

The meteorological information classifying unit 210 automatically classifies various types of meteorological information discriminately based on their formats. Also, when an adaptation file regarding a new meteorological information format is received, the meteorological information classifying unit 210 adds a new meteorological information format through a confirmation procedure.

The meteorological information parsing unit 220 performs parsing to cut meteorological information classified by the meteorological information classifying unit 210 by configuration fields differently depending on types based on classified contents.

The meteorological information verifying unit 230 verifies a syntax error and semantic content with respect to the meteorological information parsed by the meteorological information parsing unit 220. Through this, verification may be performed on content and grammar with respect to the meteorological information.

The meteorological message generating unit 240 generates a meteorological message by extracting only items required for air control from the meteorological information verified by the meteorological information verifying unit 230.

The meteorological message transmission unit 250 transmits the meteorological message generated by the meteorological message generating unit 240 to the CWP systems that ultimately perform air control.

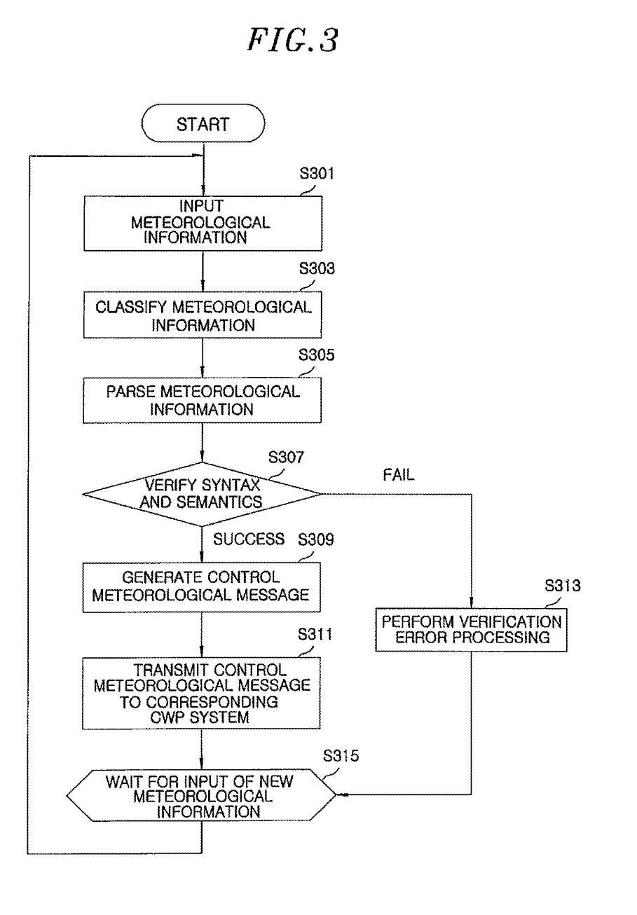

FIG. 3 is a flow chart illustrating a method for automatically applying meteorological information performed by the apparatus for automatically applying meteorological information in accordance with an embodiment of the present invention.

As shown in FIG. 3, the method for automatically applying meteorological information includes, when various types of meteorological information is input in step S301, automatically classifying the input meteorological information depending on their types in step S303, performing parsing to cut the classified meteorological information by configuration fields differently depending on types based on classified contents in step S305, verifying a syntax error and semantic content with respect to the parsed meteorological information in step S307, generating a meteorological message by extracting only items required for air control from successfully verified meteorological information in step S309, transmitting the generated meteorological message to CWP systems that ultimately perform air control in step S311, performing verification error processing on verification-failed meteorological information in step S313, and waiting for an input of new meteorological information after transmission of a meteorological message or the verification error processing in step S315.

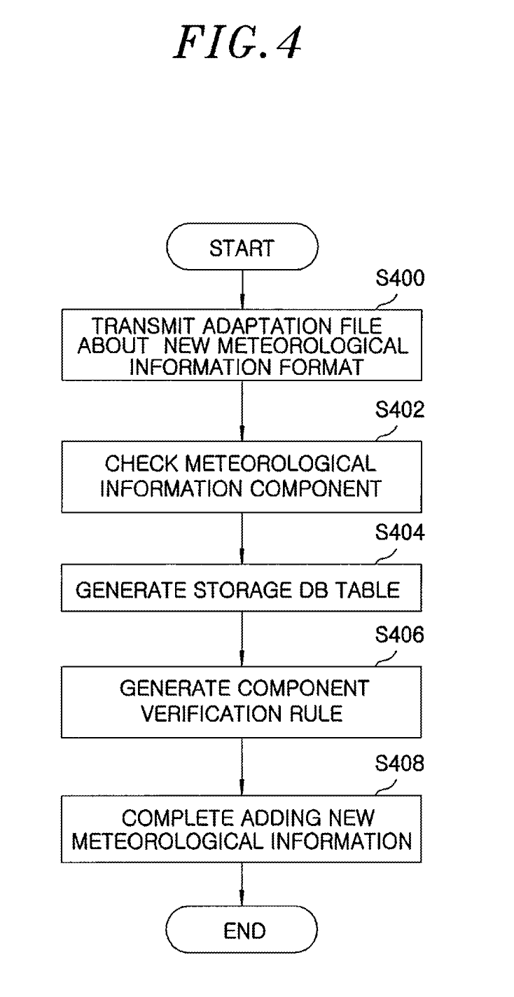

FIG. 4 is a flow chart illustrating a method for adding a meteorological information format performed by the apparatus for automatically applying meteorological information in accordance with an embodiment of the present invention.

As shown in FIG. 4, the method for adding a meteorological information format includes when an adaptation file about the new meteorological information format is transmitted from the air control integrated management system 120 in steps S400, checking a meteorological information component about the new meteorological information format in step S402, generating a storage database table for storing the corresponding meteorological information based on the checked component in step S404, generating a component verification rule applied based on information of the checked component in step S406, and completing adding the new meteorological information format when the generation of the storage database table and the component verification rule is completed in step S408.

Hereinafter, the method for automatically applying meteorological information and adding a format performed by the apparatus for automatically applying meteorological information in accordance with an embodiment of the present invention will be described based on time series with reference to FIGS. 1 to 4.

First, when various types of meteorological information are transmitted from the AFTN/ATN 110, the aviation meteorological agency 140, the central meteorological unit 150 or the like, the flight data processing system 140 receives the information in step S301.

Then, the meteorological information classifying unit 210 constituting the apparatus 200 for automatically applying meteorological information included in the flight data processing system 130 automatically classifies the various types of meteorological information discriminately based on their formats in step S303.

Meanwhile, when an adaptation file with respect to a new meteorological information format is transmitted from the air control integrated management system 120, the flight data processing system 130 receives it in step S400.

Then, the meteorological information classifying unit 210 constituting the apparatus 200 for automatically applying meteorological information included in the flight data processing system 130 checks a meteorological information component with respect to the new meteorological information format in step S402.

Further, the meteorological information classifying unit 210 generates a storage database table for storing the corresponding meteorological information based on the checked component in step S404. For example, the storage database table may be generated in the flight data processing system 130.

In addition, the meteorological information classifying unit 210 generates a component verification rule applied based on information regarding the checked component in step S406, stores the generated component verification rule in the corresponding storage database table, and subsequently completes adding of a new meteorological information format in step S408. The additionally stored component verification rule is used in a verification procedure of step S307 later.

Next, the meteorological information parsing unit 220 of the apparatus 200 for automatically applying meteorological information performs parsing to cut the classified meteorological information by configuration fields differently depending on their types based on the classified content in step S305.

Further, the meteorological information verifying unit 230 included in the apparatus 200 for automatically applying meteorological information verifies a syntax error and semantic content of the parsed meteorological information. Accordingly, the content and grammar of the meteorological information may be verified in step S307.

Thereafter, if the verification succeeds in step S307, the meteorological message generating unit 240 included in the apparatus 200 for automatically applying meteorological information extracts only items required for air control from successfully verified meteorological information to generate a meteorological message in step S309.

Subsequently, the meteorological message transmission unit included in the apparatus 200 for automatically applying meteorological information transmits the generated meteorological message to the CWP systems that ultimately perform air control in step S311.

On the other hand, if the verification fails in step S307, the meteorological information verifying unit 230 performs verification error processing on verification-failed meteorological information in step S313.

After the transmission of the meteorological message in step S311 or the verification error processing in step S313, the meteorological information classifying unit 210 waits for an input of new meteorological information in step S315. Thereafter, if new meteorological information is input, the control process repeats from step S301 to step S315.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for automatically applying meteorological information, the apparatus comprising:
a meteorological information classifying unit configured to automatically classify various types of meteorological information discriminately depending on their formats;
a meteorological information parsing unit configured to perform parsing to cut meteorological information classified by the meteorological information classifying unit by configuration fields differently depending on their types based on classified content;
a meteorological information verifying unit configured to verify a syntax error and semantic content with respect to the meteorological information parsed by the meteorological information parsing unit;
a meteorological message generating unit configured to generate a meteorological message by extracting only items required for air control from the meteorological information verified by the meteorological information verifying unit; and
a meteorological message transmission unit configured to transmit the meteorological message generated by the meteorological message generating unit to a controller working position (CWP) system that performs air control.

2. The apparatus of claim 1, wherein when an adaptation file regarding a new meteorological information format is received, the meteorological information classifying unit adds a new meteorological information format through a confirmation procedure.

3. A method for automatically applying meteorological information by an apparatus for automatically applying meteorological information, the method comprising:
automatically classifying various types of input meteorological information discriminately depending on their formats;
performing parsing to cut the classified meteorological information by configuration fields differently depending on types based on classified content;
verifying a syntax error and semantic content with respect to the parsed meteorological information;
generating a meteorological message by extracting only items required for air control from successfully verified meteorological information; and
transmitting the generated meteorological message to a controller working position (CWP) system that performs air control.

4. The method of claim 3, further comprising:
when an adaptation file regarding a new meteorological information format is received, adding a new meteorological information format for aircraft traffic control through a confirmation procedure.

5. The method of claim 4, wherein said adding a new meteorological information format further includes:
checking a meteorological information component with respect to the new meteorological information format;
generating a storage database table for storing the corresponding meteorological information based on the checked meteorological information component; and
generating a component verification rule applied based on information of the checked meteorological information component.
